(19) United States
(12) Patent Application Publication
(10) Pub. No.: US 2010/0251007 A1
(43) Pub. Date: Sep. 30, 2010

(54) FILE TRANSPORT IN DYNAMIC ENVIRONMENTS

(75) Inventors: Charles Chapman Moore, Plano, TX (US); James Marshall Korns, Richardson, TX (US)

Correspondence Address: DOCKET CLERK, P.O. DRAWER 800889, DALLAS, TX, 75380, US

(73) Assignee: Enfora, Inc., Richardson, TX (US)

(21) Appl. No.: 12/411,363

(22) Filed: Mar. 25, 2009

(51) Int. Cl. G06F 11/14

(52) U.S. Cl. 714/4; 714/E11.131

(57) ABSTRACT

Systems and methods are disclosed that include transferring data using a client. The client experiences a disruption event and determines the nature of the disruption event. In addition, these systems and methods may include adjusting for the disruption event. The adjustment of the disruption event is performed automatically using at least one processor in the client and resuming the transmitting of data after adjusting for the disruption event.

### TECHNICAL FIELD

Generally, the invention relates to computer networks and wireless devices, and more particularly to the transfer and resumption transfer of files over data networks.

### BACKGROUND

Conventional methods of sending files in conventional networks have a number of problems in wireless environments. First, the available power to a mobile device in the wireless environment may be insufficient to complete the transfer of large files. Second, an alternative data route may be discovered after a file transfer has begun. If the alternative route is more desirable, the file transfer is restarted using the more desirable route. Finally, during the transfer in an environment with dynamic internet protocol (IP) addresses, there may be a need to restart the file transfer as a consequence of a new IP address.

Systems and methods that enhance the ability of file transfers in wireless environments to restart or resume transfer are needed.

### SUMMARY OF INVENTION

In one embodiment, a method is disclosed that includes transmitting data using a client. The client experiences a disruption event and determines the nature of the disruption event. In addition, these systems and methods may include adjusting for the disruption event. The adjustment of the disruption event is performed automatically using at least one processor in the client and resuming the transmission of data after adjusting for the disruption event.

In another embodiment, a system is disclosed that includes a memory configured to store instructions related to an identification of disruption events and a processor configured to execute the instructions related to the identification of disruption events stored in the memory. This system also includes a network interface coupled to the processor. The network interface is used to perform at least one file transfer, and during at least one file transfer a disruption event occurs. The processor identifies the nature of the disruption event, and adjusts the operation of the system based upon the disruption event.

In yet another embodiment, an apparatus is disclosed that has a network interface used to transmit data over a cellular network and a processor configured to provide instructions to the network interface. The processor is configured to promote the transfer of data from the wireless apparatus to a destination. Upon determining that a disruption event has occurred, the processor is further configured to determine the nature of the disruption and adjust the operation of the apparatus based upon the nature of the disruption.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts:

FIG. 1 is a block diagram of one system of implementing the enhanced file transfer (EFT) approach;

FIG. 2 is a flowchart of on method of implementing the EFT approach;

FIG. 3 is a flowchart illustrating one method of determining the nature of a disruption event;

FIG. 4 is a flowchart illustrating the use of data segmentation in the EFT approach;

FIG. 5 is a flowchart illustrating the adjustment for external disruption events according to one embodiment of the present disclosure; and

FIG. 6 illustrates a system suitable for implementing the several embodiments of the disclosure.

### DETAILED DESCRIPTION

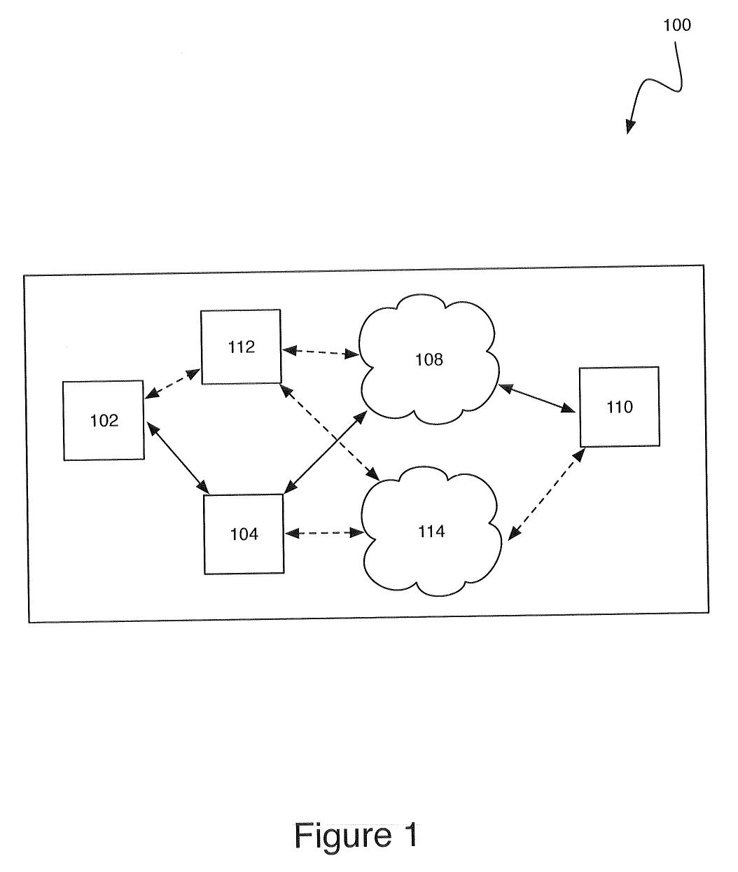

FIGS. 1 through 6, discussed below, and the various embodiments used to describe the principles of the present disclosure in this patent document are by way of illustration only and should not be construed in any way to limit the scope of the disclosure. Systems and methods are disclosed herein that relate to an enhanced file transfer (EFT) method or process for exchanging data regardless of the physical structure and functionality of the network communications hardware and devices. This EFT enables the resumption of file transfers that have been interrupted for some reason. The EFT process, in some embodiments, couples information related to internal conditions and external conditions of a mobile device and allows for the dynamic adjustment of when and how data is transferred. These and other embodiments of the present disclosure will be discussed below.

FIG. 1 is an example of an example communications system or network 100 that may utilize the EFT process approach to transfer data. FIG. 1 includes a client 102, gateway 104, a second gateway 112, a large area network 108, a second large area network 114 and a server 110. In one embodiment of the present disclosure, the client 102 initiates a file transfer session to send a file to the server 110, and/or to receive a file from server 110. Server 110 could also be some other type of device for receiving and/or transmitting files. One communications data path is established between the client 102 and the server 110, as shown using the solid lines in FIG. 1. During the transfer of a file, an interruption in the connection or file transfer between the client 102 and the server 110 may occur. Such interruption may be due to any one of a number of disruptive events, as known in the art. The client 102 will use the disclosed systems and methods for identifying the disruption event. By identifying the disruption event, the EFT process may leverage file resumption techniques thereby reducing redundant data transfer as well as reducing the time and cost for file transfers.

The client 102 is any device capable of communication with the server 110. The client 102 may be, for example, a mobile device or handset, a computer, a personal data assistant (PDA), or any other device capable of communication through a network to the server 110. In some embodiments, the client 102 is preferably a wireless capable communication device.

The gateway 104 and the second gateway 112 are intermediary devices positioned between the large area networks 108, 114 and the client 102. The gateway 104 may be used in wireless environments and configured as a base station or other device that provides connectivity between the client 102 and the large area network 108. It is understood that in some environments, the client 102 may be capable of direct communication with the large area network 108.

The large area network 108 and the second large area network 114 are conventional data or communications networks with a plurality of nodes capable of communicately connecting a plurality of devices. In one embodiment, the large area network 108 and the second large area network 114 may be a data packet network, etc. or the Internet. In another embodiment, the large area network 108 and the second large are network 114 may be an intranet. It is expressly understood that the client 110 and/or the server 102 may be further communicately connected to a plurality of networks and/or gateways or other network devices.

The server 110 may be similar in structure to the client 102. The server 110 may be any device capable of communication with the client 102 using a protocol (e.g., file transfer protocol (FTP), secure file transfer protocol (SFTP)) that supports a resume function. In some embodiments, the server 110 is a data server, which maintains an interface and connection to the large area network 108. While one server 110 is shown, it is explicitly understood that a plurality of servers may be used consistent with the present disclosure.

It is further understood that the EFT process may be used in conjunction with any known file transfer protocol that supports the ability to resume data transfers, including, but not limited to FTP, SFTP, or any other protocol known to one skilled in the art. The implementation of one example of a file transfer protocol may be found within the FTP specification, referred to as RFC 959, which is incorporated herein by reference as if reproduced in full.

When a file transfer between the client 102 and the server 110 has failed, the EFT process functions to indentify the one or more causes of the failure. For the purpose of clarity, the cause of failure will be referred to as the “disruption event”.

A disruption event refers to any condition that results in the disruption of the transfer of data between the client 102 and the server 110, including but not limited to, the loss of a TCP/IP connection. The disruption event may be determined to be internal or external. One example of an internal disruption event is when insufficient power is available to complete the transfer. One example of an external disruption event is when network conditions change thereby disrupting a file transfer. As will be appreciated, other disruption events are known to one skilled in the art.

In another embodiment, a more desirable wireless connection becomes available. For the purpose of clarity, the existence of a more desirable wireless network that causes a disruption event will be referred to as a “preferred event”. The preferred event allows for data transfer to be switched from one communications path to another communications path, and/or from one network and/or gateway to a second network and/or gateway without restarting the data transfer. For example, in FIG. 1, the client 102 is connected to wireless gateway 104 and network 102. However, it is understood that if the second connection using network 114 and gateway 112 becomes available, client 102 may switch to using the a second data path.

Examples of factors that may be used to determine the preferability of one wireless gateway over another include, but are not limited to, the financial cost associated with using the connection or path power cost associated with the connection, bandwidth of the connection, quality of the connection, or any other factor known to one skilled in the art. In one typical application, the device 102 has both Global System for Mobile (GSM) and WiFi capability, has begun data transfer over a GSM network, and enters WiFi coverage. In certain situations, WiFi performance is higher and cost is lower than data transfer over the GSM network, and the device could change the data path in order to take advantage of the new network. Possible data paths are shown by the broken lines in FIG. 1.

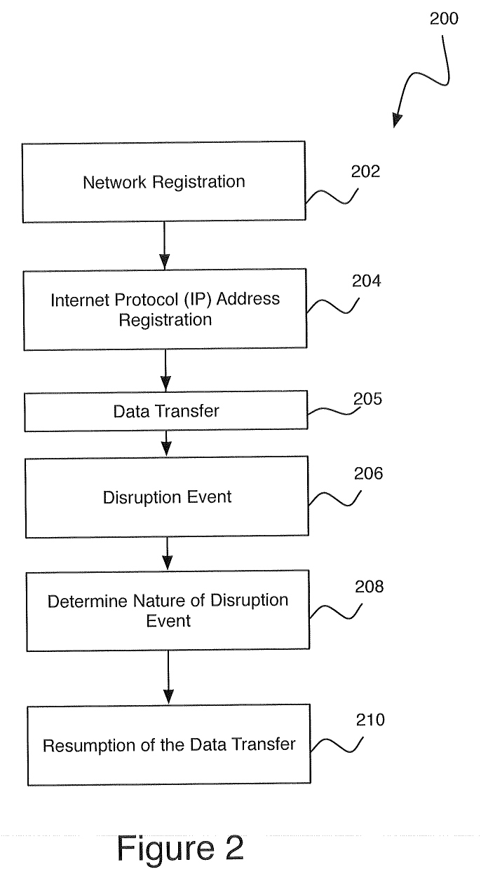

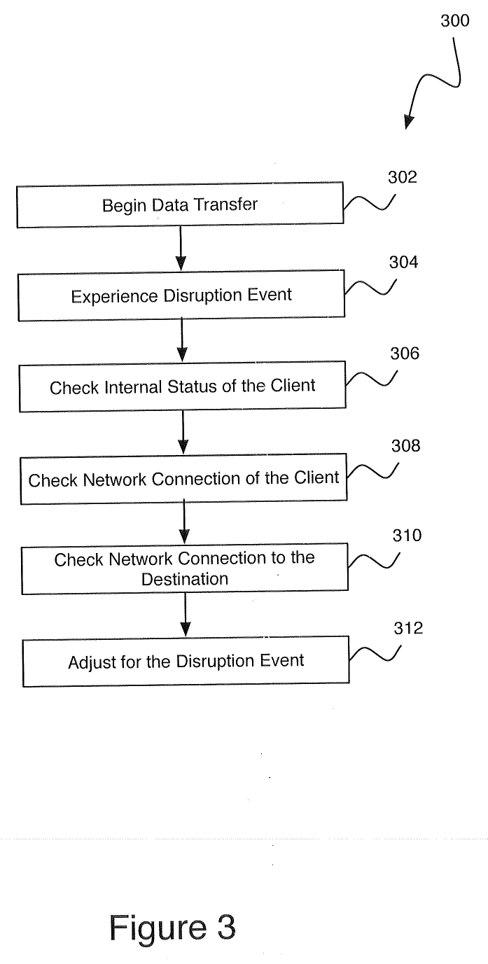

FIG. 2 provides an overview of how the EFT process enables resumption of the transfer of file(s) due to a disruption event, and FIG. 3 illustrates one method of determining or identifying the disruption event and adjusting for that detected event.

FIG. 2 illustrates the high-level approach used in one embodiment of the present disclosure. In block 202, the client 102 registers with the network. After registration is complete, in block 204 the client 102 registers an IP address with the server 110. This registration allows the server 110 to communication and identify the client 102. It is understood that in some embodiments, the IP address is associated with the network infrastructure and not with a particular destination or host. It is further understood that, in some embodiments, obtaining an appropriate IP address may allow the client 102 to access a particular network or server 110. At some point in time during the communications session, client 102 a file transfer session begins between the client 102 and the server 110 in block 205. During this file transfer, a disruption event occurs interrupting the file transfer in block 206.

In block 208, the nature of the disruption event is determined or identified. It is understood that, in some embodiments, the determination of the disruption event may be unnecessary, as the existence of the disruption event may trigger the need for a resumption event. In blocked 210, the file transfer is resumed. In some embodiments, the file transfer may use information, such as the last successful cyclic redundancy check (CRC) received relating to file that is being transferred, to resume the transfer. In other embodiments, the file transfer may be delayed until sufficient resources (e.g., power) are available to resume the file transfer.

FIG. 3 is an example of one method 300 of determining the nature of the disruption event. In this example, a data transfer begins (block 302). In block 304, a disruption event is experienced. In block 306, the internal status of the client 102 is checked. This internal status check may include, but is not limited to, the power available to the client 102 and an internal diagnostic of the client 102. In block 308, the first part of the external status of the client 102 may be to determine if the client 102 has an active network connection (e.g., connection to network 104). It is also contemplated that in block 308 the client may also determine what networks are currently available. In block 310, the route from the client 102 to the server 110 is checked. This check may be performed through a network ping or in any other way known one skilled in the art. In block 312, the disruption event is adjusted for by the client 102 when resuming the data transfer.

In some situations, the disruption event will be internal and caused by insufficient power available to the client. This situation may arise in where the client utilizes regenerative power, including power provided through motion, solar cells, or other regenerative sources. This situation may also arise in battery technologies requiring recovery time, such as lithium thionyl chloride battery packs. These regenerative sources may not allow for prolonged data transfer, and where large data files are being transferred, the regenerative source may not provide sufficient power for the data to be transferred in a single session. In this case, the client 102 will continue to transfer data until power availability has dropped below a predetermined threshold. Since the data rate of the transfer may vary, the power being consumed and the power available are continuously monitored. When available power drops below a predetermined threshold, the client 102 itself will generate a disruption event (e.g., stop transfer) and wait until all parameters necessary for resumption of transfer are met.

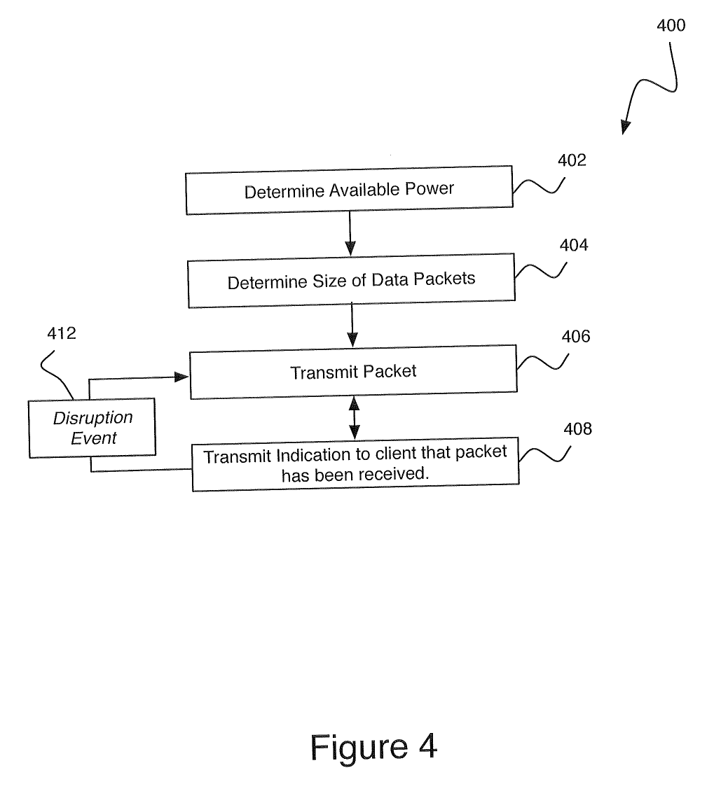

FIG. 4 is an example of one method 400 that shows a method for resuming data after a disruption event. As will be appreciated by one skilled in the art, it may not be possible to know how much data is transferred in a given time. This is because transfer rates vary based upon numerous conditions, including connection quality, connection traffic, and other network conditions. Therefore, the flowchart in FIG. 4 illustrates one method of resuming data transfer of a file that has been interrupted. In block 402, the amount of available power is determined. In block 404, the size, or length, of the data packets to be transferred is determined. In block 406, the data is transmitted in packets. In block 408, there is an indication transmitted to the client 102 that the data has been received. If the data has not been completely transferred another packet is transferred in block 406. It is understood that a disruption event may occur in block 412 in between the blocks 408 to the block 406. Such a disruption event will be compensated for as disclosed below allowing for further action to be taken.

It is explicitly understood that while the example shown above relates to the client 102 sending data to the server 110, the same method could be used (as with all methods disclosed herein) relate to the server 110 sending data to the client 102. In addition, bi-directional data transfer between the client 102 and server 110 is also contemplated.

It is further explicitly understood that while the example shown above has a single server 110 and a single client 102, the disclosed systems and methods allow a plurality of clients to communicate with a plurality or servers. It is explicitly understood that any number of servers and clients are contemplated by the present disclosure.

It is understood that transmission of an indication of data segmentation may be preferable in some embodiments, while unnecessary in others. One of the innovative elements of the present disclosure, as will be discussed below, is the ability to transmit data in segments without requiring data reconstruction at the server 110.

As will be appreciated, prior to the transmission of a particular packet, an appropriate time delay may be provided to allow the regenerative power source (e.g., in client 102) sufficient time to obtain sufficient power to transmit the data segment. The length of this delay is dependent upon the type of regenerative power source as well as the size of the battery within the client 102.

Data transferred in segments may include a single file. In other forms of data segmentation, separate files are transferred that have to be reconstructed at the server 110. The present disclosure overcomes this problem by transferring a single data stream that is stopped and subsequently resumed at a later time. In this way, the data may be segmented without the need for reconstruction at the server 110 at a later time.

It is explicitly understood that the same mechanisms described above apply in the case where the server is transmitting data to the client, and the client creates a disruption. In this case, the client reinitializes the network connection and requests additional data from the server, starting at the end of the last successful data transfer.

Another innovative feature of the present disclosure is the ability to use the disruption not only to facilitate transfer of data, but also to provide more control over the transfer. For example, a client 102 may have connections to a plurality of networks each of which has a different power cost as well as a different monetary cost. Through using disruption events that are initiated by the client 102, data may be transferred in such a way as to optimize both the power cost as well as the monetary cost. For instance, if there is a specific limitation as to how much data may be transferred over any given network without incurring additional cost, client 102 may be programmed to segment the data so as to remain below the data transfer cap. It is further contemplated that multiple successive connections and different data paths are contemplated.

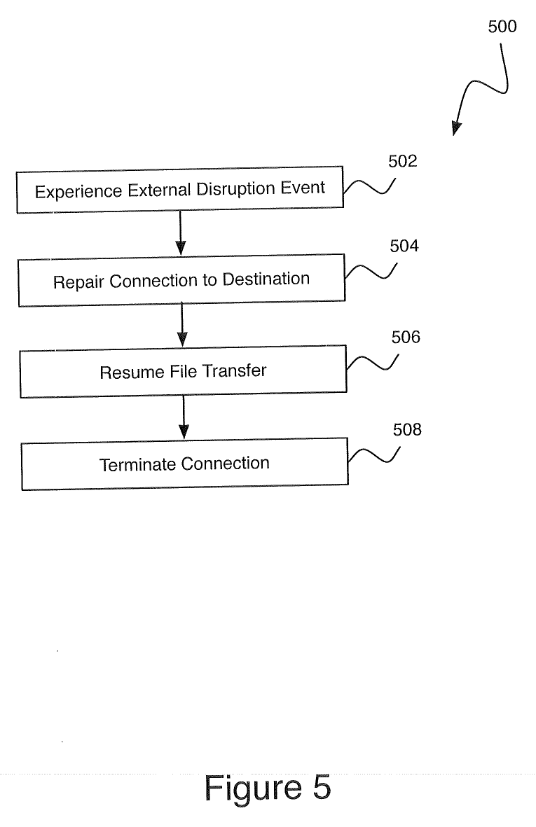

FIG. 5 is a flowchart illustrating in another embodiment 500 of the present disclosure. In this embodiment the client 102 experiences an external disruption event in block 502. This disruption event may be a consequence of the device initiating a transfer to a different network or the connection to the network being lost or reconfigured. In the block 504, the client 102 repairs the connection to the server 110. In block 506, the client resumes the file transfer to the server 110. After the file transfer is complete, the client 102 terminates its connection to the server 110.

The reconfiguring of a network connection used by client 102 may refer to a change in the IP address currently being used by the client 102. This change may be a result of a dynamic network change (e.g., the assigned IP address of client 102 changing) or client 102 moving from one network connection to another network connection. This reconfiguration of the network connection used by client 102 may result in a disruption event even though client 102 may still maintain connectivity to the server 110. In such a case, it is preferable that, if the disruption event occurred during a file or data transfer, not to have to restart the data transfer. The present systems and methods overcome this problem by allowing the client 102 to resume a data transfer, which was interrupted because of the reconfiguration of a network connection. The ability to overcome this problem is based upon the recognition that a reconfiguration has occurred, the establishment of a new connection to the server 110, and the implementation of protocols that allow for the resumption of data transfer after that data transfer has been interrupted.

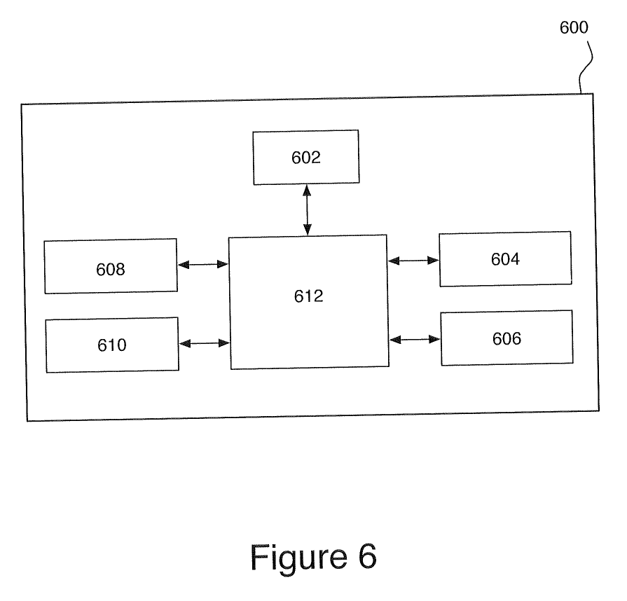

Client 102 and server 110 described above may be implemented on any system 600 with sufficient processing power, memory resources, and network throughput capability to handle the necessary workload placed upon it. FIG. 6 illustrates a system suitable for implementing one or more embodiments disclosed herein. The system 600 includes a processor 612 (which may be referred to as a central processor unit or CPU) that is in communication with memory devices including secondary storage 602, read only memory (ROM) 604, random access memory (RAM) 606, input/output (I/O) 608 devices, and network connectivity devices 610. The processor may be implemented as one or more CPU chips.

The secondary storage 602 is typically comprised of one or more disk drives or tape drives and is used for non-volatile storage of data and as an over-flow data storage device if RAM 606 is not large enough to hold all working data. Secondary storage 602 may be used to store programs that are loaded into RAM 606 when such programs are selected for execution. The ROM 604 is used to store instructions and perhaps data that are read during program execution. ROM 604 is a non-volatile memory device that typically has a small memory capacity relative to the larger memory capacity of secondary storage. The RAM 606 is used to store volatile data and perhaps to store instructions. Access to both ROM 604 and RAM 606 is typically faster than to secondary storage 602.

I/O 608 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 392 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices.

These network connectivity devices 610 may enable the processor 612 to communicate with an Internet or one or more intranets. With such a network connection, it is contemplated that the processor 612 might receive information from the network, or might output information to the network in the course of performing the above-described method steps. Such information, which is often represented as a sequence of instructions to be executed using processor 612, may be received from and outputted to the network, for example, in the form of a computer data signal embodied in a carrier wave.

Such information, which may include data or instructions to be executed using processor 612 for example, may be received from and outputted to the network, for example, in the form of a computer data baseband signal or signal embodied in a carrier wave. The baseband signal or signal embodied in the carrier wave generated by the network connectivity devices 610 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 612 executes instructions, codes, computer programs, scripts that it accesses from hard disk, floppy disk, optical disk (these various disk based systems may all be considered secondary storage 602), ROM 604, RAM 606, or the network connectivity devices 610.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other products shown or discussed as directly coupled or communicating with each other may be coupled through some interface or device, such that the products may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

It should be understood that although an exemplary implementation of one embodiment of the present disclosure is illustrated above, the present system may be implemented using any number of techniques, whether currently known or in existence. The present disclosure should in no way be limited to the exemplary implementations, drawings, and techniques illustrated above, including the exemplary design and implementation illustrated and described herein, but may be modified within the scope of the appended claims along with their full scope of equivalents.

What is claimed is:

1. A method, comprising:
transmitting at least a first portion of data in a data file to at least one communication device;
experiencing a disruption event;
identifying the disruption event;
adjusting for the disruption event, wherein the adjustment of the disruption event is performed automatically using at least one processor in the communication device; and
transmitting at least a second portion of data in the data file to the at least one communication device.

2. The method of claim 1, wherein the transmitting of data comprises transferring a file using the file transfer protocol to or from at least one server.

3. The method of claim 1, wherein the determination of the nature of the disruption event comprises identifying whether the disruption event is an internal disruption event.

4. The method of claim 3, wherein the internal disruption results from limitations in power available to the communication device.

5. The method of claim 2, wherein upon determining that the disruption event is external, determining if a new data path exists to the at least one server.

6. The method of claim 1, wherein the disruption event is caused by a change in the network configuration.

7. The method of claim 5, wherein the disruption event is created upon the discovery of a preferred network.

8. The method of claim 7, wherein the file is transferred over a wireless cellular network.

9. The method of claim 1, wherein the client is transmitted data to a plurality of servers.

10. The method of claim 4, wherein the separate parts are transmitted at intervals allowing for the preservation of battery life in the communication device.

11. A system, comprising:
a memory configured to store instructions related to an identification of disruption events;
a processor configured to execute the instructions related to the identification of disruption events stored in the memory; and
a network interface coupled to the processor, wherein the network interface is used to perform at least one file transfer, and wherein during the at least one file transfer a disruption event occurs, and wherein the processor identifies the nature of the disruption event, and wherein the processor then adjusts the operation of the system based upon the disruption event.

12. The system of claim 11, wherein the system is comprised within a wireless mobile device with rechargeable limited power availability.

13. The system of claim 12, wherein the processor is configured to determine if the disruption is internal disruption event or an external disruption event.

14. The system of claim 13, wherein upon determining the disruption event is an internal event, determining the power status of the system.

15. The system of claim 13, wherein upon determining the disruption event is an external event, checking the network interface connection to at least one server.

16. The system of claim 13, wherein upon determining the disruption event is an internal event, determining the power status of the system.

17. A wireless device apparatus, comprising:
a network interface configured to transmit data over a cellular network;
a processor configured to provide instructions to the network interface, wherein the processor is configured to promote the transfer of data from the wireless apparatus to a destination, and wherein upon determining that a disruption event has occurred, the processor is further configured to determine the nature of the disruption and adjust the operation of the apparatus based upon the nature of the disruption.

18. The apparatus of claim 17, wherein the network interface operates over a global packet radio system (GPRS) network.

19. The apparatus of claim 17, wherein the processor determines if the nature of the disruption is internal or external.

20. The apparatus of claim 17, wherein the processor is configured to determine if an alternative data path is available to the destination, and wherein the processor is further configured to reroute traffic to this alternate data path.
